(19) United States
(12) Patent Application Publication
(10) Pub. No.: US 2022/0414222 A1
(43) Pub. Date: Dec. 29, 2022

(54) TRUSTED PROCESSOR FOR SAVING GPU CONTEXT TO SYSTEM MEMORY

(71) Applicants: ADVANCED MICRO DEVICES, INC., Santa Clara, CA (US); ATI TECHNOLOGIES ULC, Markham (CA)

(72) Inventors: Gia Phan, Markham (CA); Ashish Jain, Santa Clara, CA (US); Randall Brown, Markham (CA)

(21) Appl. No.: 17/356,776

(22) Filed: Jun. 24, 2021

(51) Int. Cl. G06F 21/57; G06F 21/60; G06F 9/46; G06F 9/50; G06T 1/20

(52) U.S. Cl. CPC G06F 21/57; G06F 21/602; G06F 9/461; G06F 9/5016; G06T 1/20

(57) ABSTRACT

A trusted processor saves and restores context and data stored at a frame buffer of a GPU concurrent with initialization of a CPU of the processing system. In response to detecting that the GPU is powering down, the trusted processor accesses the context of the GPU and data stored at a frame buffer of the GPU via a high-speed bus. The trusted processor stores the context and data at a system memory, which maintains the context and data while the GPU is powered down. In response to detecting that the GPU is powering up again, the trusted processor restores the context and data to the GPU, which can be performed concurrently with initialization of the CPU.

### BACKGROUND

Processing units including but not limited to processors such as graphics processing units (GPUs), massively parallel processors, single instruction multiple data (SIMD) architecture processors, and single instruction multiple thread (SIMT) architecture processors can improve performance or conserve power by transitioning between different power management states. For example, a processing unit can conserve power by idling when there are no instructions to be executed by the processing unit. When a processing unit becomes idle, power management hardware or software may reduce dynamic power consumption. In some cases, a processing unit may be power gated (i.e., may have power removed from it) or partially power gated (i.e., may have power removed from parts of it) if the processing unit is predicted to be idle for more than a predetermined time interval. Power gating a processing unit is referred to as placing the processing unit into a deep sleep, or powered down, state. Powering down a GPU requires saving content stored at a frame buffer or other power gated areas of the GPU to system memory. Transitioning the GPU from a low power state (such as an idle or power gated or partially power gated state) to an active state exacts a performance cost in reinitializing the GPU and copying back content stored at system memory to the frame buffer.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including a trusted processor to save and restore context and content of a graphics processing unit (GPU) concurrent with initialization of a CPU in accordance with some embodiments.

FIG. 2 is a block diagram of the trusted processor saving context and content of the GPU to system memory in response to the GPU powering down in accordance with some embodiments.

FIG. 3 is a block diagram of the trusted processor restoring the context and content of the GPU from the system memory to the GPU in response to the GPU powering up in accordance with some embodiments.

FIG. 4 is a block diagram of the trusted processor encrypting and hashing the data and context of the GPU prior to storing the data and context at the system memory in accordance with some embodiments.

FIG. 5 is a block diagram of the trusted processor verifying that the context and data are untampered in accordance with some embodiments.

FIG. 6 is a block diagram of a driver allocating a portion of system memory for storing the context and data of the GPU in accordance with some embodiments.

FIG. 7 is a flow diagram illustrating a method for saving and restoring context and content of a GPU concurrent with initialization of a CPU in accordance with some embodiments.

### DETAILED DESCRIPTION

A parallel processor is a processor that is able to execute a single instruction on a multiple data or threads in a parallel manner. Examples of parallel processors include processors such as graphics processing units (GPUs), massively parallel processors, single instruction multiple data (SIMD) architecture processors, and single instruction multiple thread (SIMT) architecture processors for performing graphics, machine intelligence or compute operations. In some implementations, parallel processors are separate devices that are included as part of a computer. In other implementations such as advance processor units, parallel processors are included in a single device along with a host processor such as a central processor unit (CPU). Although the below description uses a graphics processing unit (GPU), for illustration purposes, the embodiments and implementations described below are applicable to other types of parallel processors.

A GPU is a processing unit that is specially designed to perform graphics processing tasks. A GPU may, for example, execute graphics processing tasks required by an end-user application, such as a video game application. Typically, there are several layers of software between the end-user application and the GPU. For example, in some cases the end-user application communicates with the GPU via an application programming interface (API). The API allows the end-user application to output graphics data and commands in a standardized format, rather than in a format that is dependent on the GPU.

Many GPUs include a plurality of internal engines and graphics pipelines for executing instructions of graphics applications. A graphics pipeline includes a plurality of processing blocks that work on different steps of an instruction at the same time. Pipelining enables a GPU to take advantage of parallelism that exists among the steps needed to execute the instruction. As a result, a GPU can execute more instructions in a shorter period of time. The output of the graphics pipeline is dependent on the state of the graphics pipeline. The state of a graphics pipeline is updated based on state packages (e.g., context-specific constants including texture handlers, shader constants, transform matrices, and the like) that are locally stored by the graphics pipeline. Because the context-specific constants are locally maintained, they can be quickly accessed by the graphics pipeline.

To perform graphics processing, a central processing unit (CPU) of a system often issues to a GPU a call, such as a draw call, which includes a series of commands instructing the GPU to draw an object according to the CPU's instructions. As the draw call is processed through the GPU graphics pipeline, the draw call uses various configurable settings to decide how meshes and textures are rendered. A common GPU workflow involves updating the values of constants in a memory array and then performing a draw operation using the constants as data. A GPU whose memory array contains a given set of constants may be considered to be in a particular state or have a particular context. These constants and settings, referred to as context (also referred to as “context state”, “rendering state”, “GPU state”, or “GPU context”), affect various aspects of rendering and include information the GPU needs to render an object. The context provides a definition of how meshes are rendered and includes information such as the current vertex/index buffers, the current vertex/pixel shader programs, shader inputs, texture, material, lighting, transparency, and the like. The context contains information unique to the draw or set of draws being rendered at the graphics pipeline. The GPU context also includes compute, video, display, and machine learning contexts. Each internal GPU engine includes a context. “Context” therefore refers to the required GPU pipeline state to correctly draw something as well as the compute, video, display, and machine learning contexts for each internal GPU engine of the GPU.

The context is locally maintained at a GPU memory (i.e., a frame buffer) for quick access by the graphics pipeline. The frame buffer also stores additional data such as firmware, application data, and GPU configurational data (collectively referred to as “data”). In addition, each of the internal GPU engines (microprocessors) includes firmware, registers and a static random access memory (SRAM). The GPU is also connected to a non-volatile memory such as an electrically erasable programmable read-only memory (EEPROM) by a relatively slow serial bus. The EEPROM is configured to store microcontroller firmware for each of the internal GPU engines, GPU subsystem specific data, and sequence instructions on how to initialize the GPU. In a normal boot sequence that occurs when the GPU is powered up after being placed in a fully or partially power gated state, the GPU retrieves the microcontroller firmware over the slow serial bus interface and follows the initialization sequences, including subsystem training, calibration, and set up, which is typically a relatively lengthy process. A driver is then invoked to carry some of the microcontroller firmware and load the microcontroller firmware to the internal GPU engines from the CPU. The driver also initializes the internal GPU engines.

However, accessing the microcontroller firmware via the serial bus and invoking the driver to initialize the internal GPU engines is time-consuming and therefore limits the opportunities for placing the GPU is a powered down mode. In addition, the driver is invoked by an operating system of the processing system, which is unavailable when the CPU is also powered down or busy serving other devices in the processing system.

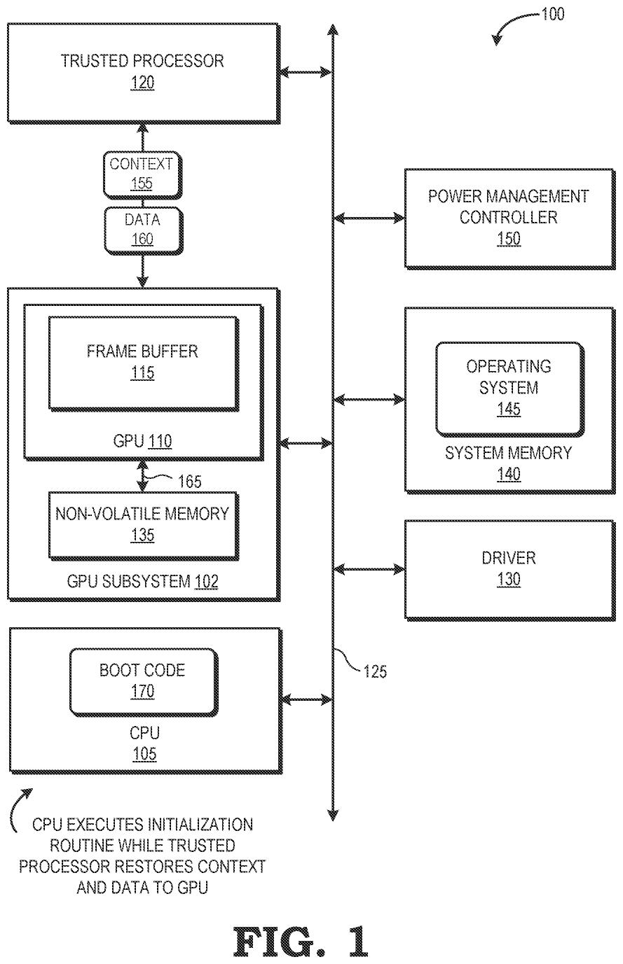

FIGS. 1-7 illustrate techniques for using a trusted processor of a processing system to save and restore context and content of a GPU concurrent with initialization of a CPU of the processing system. In response to detecting that the GPU is powering down (i.e., transitioning to a fully or partially power gated state), the trusted processor accesses the context of the GPU, including all initialization settings, and data stored at a frame buffer of the GPU before the GPU enters a low power state. In some embodiments, the trusted processor accesses the context via a high-speed bus such as a peripheral component interconnect express (PCIe) high-speed serial bus. The trusted processor also saves data such as the firmware, registers, and SRAM from the internal GPU engines that are being power gated to system memory. The trusted processor stores the context and data at off-chip memory such as system memory dynamic random-access memory (DRAM), which maintains the context and data while the GPU is powered down. In response to detecting that the GPU is powering up again, the trusted processor restores the context directly to the internal GPU engines in lieu of reinitialization, retraining, recalibration, and re-setup when the GPU exits the low power state. In addition, the trusted processor restores the data such as firmware, registers, and SRAM to the internal GPU engines when the internal GPU engines exit the low power state before the CPU can trigger the driver to reinitialize. Thus, restoration of the context and data to the internal GPU engines is independent of driver initialization or CPU scheduling and can be performed concurrently with initialization of the CPU.

In some embodiments, the trusted processor detects tampering of the context and data prior to restoring the context and data to the GPU. The trusted processor protects the context and data from tampering by hashing the context and data to generate a first hash value and encrypting the context and data prior to storing the context and data at the system memory. In response to detecting that the GPU is powering up, the trusted processor accesses the encrypted context and data and hashes the context and data to generate a second hash value. The trusted processor compares the first hash value to the second hash value to detect tampering prior to decrypting and restoring the context and data to the GPU.

In some embodiments, the system memory includes a pre-reserved portion for storing the GPU context and data. If the system memory does not include a pre-reserved portion for storing the GPU context and data, in some embodiments, a driver dynamically allocates a portion of the system memory for storing the context and data in response to the GPU powering down.

By leveraging the trusted processor to save and restore the context and data to the GPU in response to the GPU powering down and then powering up again, the GPU can bypass the reinitialization process when the GPU powers up. In addition, the trusted processor can restore the GPU context and data in parallel with the CPU powering up, without having to wait for the operating system to invoke the driver. The trusted processor further detects tampering of the context and data, providing security for the GPU data. The techniques described herein are, in different embodiments, employed at any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like).

FIG. 1 illustrates a processing system 100 including a trusted processor 120 to save and restore context 155 and content (illustrated as data 160) of a graphics processing unit (GPU) 110 concurrent with initialization of a CPU 105 in accordance with some embodiments. The GPU 110 is part of a GPU subsystem 102 that includes the GPU 110, a frame buffer 115, and a non-volatile memory 135 that is connected to the GPU 110 via a serial bus 165. In some embodiments, the components of the GPU subsystem 102 are soldered to a printed circuit board (PCB) (not shown). The processing system 100 also includes a power management controller 150, a system memory 140, a driver 130, and an interconnect 125. The processing system 100 is generally configured to execute sets of instructions (e.g., applications) that, when executed, manipulate one or more aspects of an electronic device in order to carry out tasks specified by the sets of instructions. Accordingly, in different embodiments the processing system 100 is part of one of a variety of electronic devices, such as desktop computer, laptop computer, server, smartphone, tablet, game console, and the like.

In various embodiments, the CPU 105 includes one or more single- or multi-core CPUs. In various embodiments, the GPU 110 includes any cooperating collection of hardware and/or software that perform functions and computations associated with accelerating graphics processing tasks, data parallel tasks, nested data parallel tasks in an accelerated manner with respect to resources such as conventional CPUs, conventional graphics processing units (GPUs), and combinations thereof. In the embodiment of FIG. 1, the GPU subsystem 102 is an add-in card to the processing system 100 such that a user can add or replace the GPU subsystem 102. It should be appreciated that processing system 100 may include more or fewer components than illustrated in FIG. 1. For example, processing system 100 may additionally include one or more input interfaces, non-volatile storage, one or more output interfaces, network interfaces, and one or more displays or display interfaces.

Access to system memory 140 is managed by a memory controller (not shown), which is coupled to system memory 140. For example, requests from the CPU 105 or other devices for reading from or for writing to system memory 140 are managed by the memory controller. In some embodiments, one or more applications (not shown) include various programs or commands to perform computations that are also executed at the CPU 105. The CPU 105 sends selected commands for processing at the GPU 110. The operating system 145 and the interconnect 125 are discussed in greater detail below. The processing system 100 further includes a device driver 130 and a memory management unit, such as an input/output memory management unit (IOMMU) (not shown). Components of processing system 100 are implemented as hardware, firmware, software, or any combination thereof. In some embodiments the processing system 100 includes one or more software, hardware, and firmware components in addition to or different from those shown in FIG. 1.

Within the processing system 100, the system memory 140 includes non-persistent memory, such as DRAM (not shown). In various embodiments, the system memory 140 stores processing logic instructions, constant values, variable values during execution of portions of applications or other processing logic, or other desired information. For example, in various embodiments, parts of control logic to perform one or more operations on CPU 105 reside within system memory 140 during execution of the respective portions of the operation by CPU 105. During execution, respective applications, operating system functions, processing logic commands, and system software reside in system memory 140. Control logic commands that are fundamental to operating system 145 generally reside in system memory 140 during execution. In some embodiments, other software commands (e.g., a set of instructions or commands used to implement a device driver 130) also reside in system memory 140 during execution of processing system 100. In some embodiments, the GPU subsystem 102 includes additional non-volatile memory, or dedicated memory that is either on-chip or off-chip with a dedicated power rail such that the memory remains powered up when the GPU 110 is powered down (i.e., fully or partially power gated) that the GPU context and data can be saved to and restored from.

In various embodiments, the communications infrastructure (referred to as interconnect 125) interconnects the components of processing system 100. Interconnect 125 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some embodiments, interconnect 125 also includes an Ethernet network or any other suitable physical communications infrastructure that satisfies an application's data transfer rate requirements. Interconnect 125 also includes the functionality to interconnect components, including components of processing system 100.

A driver, such as driver 130, communicates with a device (e.g., GPU 110) through an interconnect or the interconnect 125. When a calling program invokes a routine in the driver 130, the driver 130 issues commands to the device. Once the device sends data back to the driver 130, the driver 130 invokes routines in an original calling program. In general, device drivers are hardware-dependent and operating-system-specific to provide interrupt handling required for any necessary asynchronous time-dependent hardware interface. In various embodiments, the driver 130 controls operation of the GPU 110 by, for example, providing an application programming interface (API) to software (e.g., applications) executing at the CPU 105 to access various functionality of the GPU 110.

The CPU 105 includes (not shown) one or more of a control processor, field programmable gate array (FPGA), application specific integrated circuit (ASIC), or digital signal processor (DSP). The CPU 105 executes at least a portion of the control logic that controls the operation of the processing system 100. For example, in various embodiments, the CPU 105 executes the operating system 145, the one or more applications, and the device driver 130. In some embodiments, the CPU 105 initiates and controls the execution of the one or more applications by distributing the processing associated with one or more applications across the CPU 105 and other processing resources, such as the GPU 110.

The GPU 110 executes commands and programs for selected functions, such as graphics operations and other operations that are particularly suited for parallel processing. In general, GPU 110 is frequently used for executing graphics pipeline operations, such as pixel operations, geometric computations, and rendering an image to a display. In some embodiments, GPU 110 also executes compute processing operations (e.g., those operations unrelated to graphics such as video operations, physics simulations, computational fluid dynamics, etc.), based on commands or instructions received from the CPU 105. For example, such commands include special instructions that are not typically defined in the instruction set architecture (ISA) of the GPU 110. In some embodiments, the GPU 110 receives an image geometry representing a graphics image, along with one or more commands or instructions for rendering and displaying the image. In various embodiments, the image geometry corresponds to a representation of a two-dimensional (2D) or three-dimensional (3D) computerized graphics image.

The power management controller (PMC) 150 carries out power management policies such as policies provided by the operating system 145 implemented in the CPU 105. The PMC 150 controls the power states of the GPU 110 by changing an operating frequency or an operating voltage supplied to the GPU 110 or compute units implemented in the GPU 110. Some embodiments of the CPU 105 also implement a separate PMC (not shown) to control the power states of the CPU 105. The PMC 150 initiates power state transitions between power management states of the GPU 110 to conserve power, enhance performance, or achieve other target outcomes. Power management states can include an active state, an idle state, a power-gated state, and some other states that consume different amounts of power. For example, the power states of the GPU 110 can include an operating state, a halt state, a stopped clock state, a sleep state with all internal clocks stopped, a sleep state with reduced voltage, and a power down state. Additional power states are also available in some embodiments and are defined by different combinations of clock frequencies, clock stoppages, and supplied voltages.

If both the CPU 105 and GPU 110 are in a power down state and the PMC 150 transitions the CPU 105 and GPU 110 to an active state, conventionally a bootloader (not shown) performs initialization of the hardware of the CPU 105 and loads the operating system (OS) 145. The bootloader then hands control to the OS 145, which initializes itself and configures the processing system 100 hardware by, for example, setting up memory management, setting timers and interrupts, and loading the device driver 130. In some embodiments, the bootloader includes boot code 170 such as a Basic Input/Output System (BIOS) and a hardware configuration (not shown) indicating the hardware configuration of the CPU 105.

The non-volatile memory 135 is implemented by flash memory, EEPROM, or any other type of memory device and is connected to the GPU 110 via a serial bus 165. Conventionally, when the GPU 110 is powered up after being placed in a fully or partially power gated state, the GPU 110 retrieves microcontroller firmware stored at the non-volatile memory 135 over the serial bus 165 and follows initialization sequences, including subsystem training, calibration, and set up, which is typically a relatively lengthy process. The CPU 105 then invokes the driver 130 to carry some of the microcontroller firmware and load the microcontroller firmware to the internal GPU engines (not shown) from the CPU 105 and initialize the internal GPU engines.

The trusted processor 120 acts as a hardware root of trust for the GPU 110. The trusted processor 120 includes a microcontroller or other processor responsible for creating, monitoring and maintaining the security environment of the GPU 110. For example, in some embodiments the trusted processor manages the boot process, initializes various security related mechanisms, and monitors the GPU 110 for any suspicious activity or events and implementing an appropriate response.

To facilitate a faster resume time for power state transitions of the GPU 110, the processing system uses the trusted processor 120 to directly access system memory 140 to save and restore GPU context 155 and data 160 without involvement of the driver 130 running on the CPU 105. In response to detecting that the GPU 110 is powering down, the trusted processor 120 accesses the context 155 of the GPU 110 and data 160 stored at a frame buffer 115 of the GPU 110 via the interconnect 125. The trusted processor 120 stores the context 155 and data 160 at the system memory 140. The system memory 140 maintains the context 155 and data 160 during the time when the GPU 110 is powered down. In response to detecting that the GPU 110 is powering up again, the trusted processor 120 restores the context 155 and data 160 to the GPU 110. In some embodiments, the trusted processor 120 is implemented in the GPU 110 and is powered down with the GPU 110 in the event the GPU 110 is fully powered down. When power is ungated, the trusted processor 120 wakes up and executes the restore sequence. For example, in some embodiments, the trusted processor 120 issues a direct memory access command to the system memory 140 to transfer the context 155 and data 160 in response to waking up. Because the trusted processor 120 performs direct memory accesses to the system memory 140 independent of the driver 130, the trusted processor 120 is able to restore the context 155 and data 160 to the GPU 110 such that the GPU 110 can resume operations in a powered up data concurrently with initialization of the CPU 105. By facilitating a faster resume time for the GPU 110, the trusted processor 120 provides the PMC 150 with more opportunities to power down the GPU 110, resulting in higher efficiency for the processing system 100 without the expense of adding more persistent memory to the processing system 100.

In some embodiments, rather than storing the context 155 and data 160 at the system memory 140 when the GPU 110 is partially or fully power gated, the trusted processor 120 stores the context 155 and data 160 at another memory of the processing system 100. For example, in some embodiments, the trusted processor 120 stores the context 155 and data 160 at additional non-volatile memory (not shown), or dedicated memory (not shown) that is either on-chip or off-chip with a dedicated power rail (not shown) such that the memory remains powered up when the GPU 110 is powered down (i.e., fully or partially power gated).

In some embodiments, the trusted processor 120 detects tampering of the context 155 and data 160 prior to restoring the context 155 and data 160 to the GPU 110. The trusted processor hashes the context 155 and data 160 to generate a first hash value (not shown) and encrypting the context 155 and data 160 prior to storing the context 155 and data 160 at the system memory 140. In response to detecting that the GPU 110 is powering up, the trusted processor 120 accesses the encrypted context 155 and data 160 and hashes the context 155 and data 160 to generate a second hash value (not shown). The trusted processor 120 compares the first hash value to the second hash value to detect tampering prior to decrypting and restoring the context 155 and data 160 to the GPU 110.

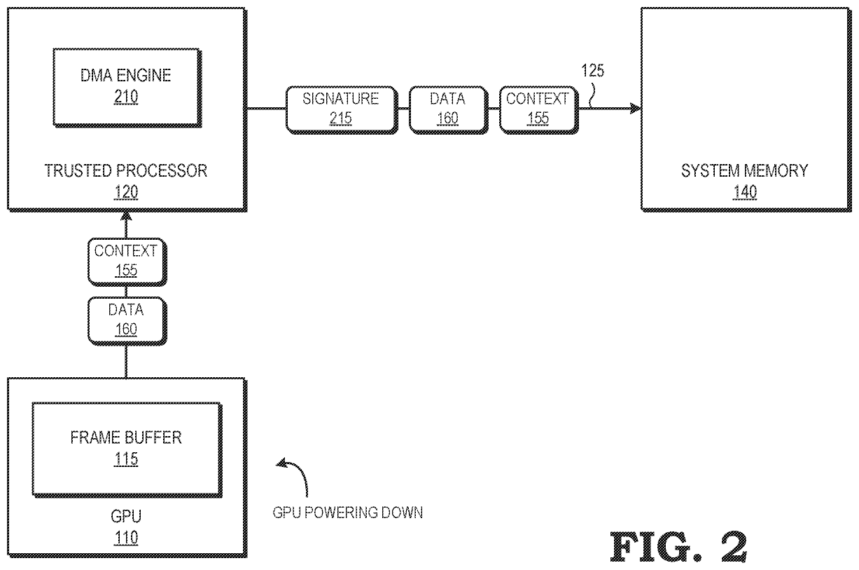

FIG. 2 is a block diagram of the trusted processor 120 saving context 155 and data 160 of the GPU 110 to system memory 140 in response to the GPU 110 powering down in accordance with some embodiments. The trusted processor 120 includes a direct memory access (DMA) engine 210 that reads or write blocks of information from the system memory 140. The DMA engine 210 generates addresses and initiates memory read or write cycles. Thus, the trusted processor 210 reads information from the system memory 140 and write information to the system memory 140 via the DMA engine 210. In some embodiments, the DMA engine 210 is implemented in the trusted processor 120 and in other embodiments the DMA engine 210 is implemented as a separate entity from the trusted processor 120. The trusted processor 120 can perform other operations concurrently with the data transfers being performed by the DMA engine 210, which may provide an interrupt to the trusted processor 120 to indicate that the transfer is complete.

In the illustrated example, in response to detecting that the GPU 110 is powering down, the trusted processor 120 retrieves the context 155 and the contents (data 160) of the frame buffer 115 of the GPU 110. The DMA engine 210 writes the context 155 and data 160 to the system memory 140. In some embodiments, the trusted processor 120 authenticates the context 155 and data 160 by, for example, appending a signature 215 to the context 155 and data 160.

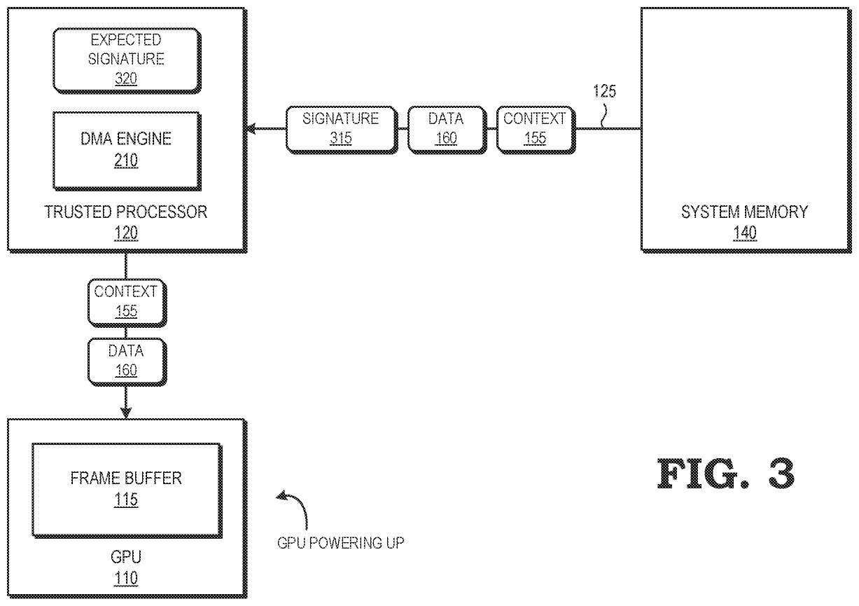

FIG. 3 is a block diagram of the trusted processor 120 restoring the context 155 and content 160 of the GPU 110 from the system memory 140 to the GPU 110 in response to the GPU 110 powering up in accordance with some embodiments. In the illustrated example, in response to detecting that the GPU 110 is powering up, the DMA engine 210 retrieves the context 155 and data 160 from the system memory 140. In some embodiments, the trusted processor 120 authenticates the context 155 and data 160 by, for example, verifying that a signature 315 appended to the context 155 and data 160 matches an expected signature 320 when the trusted processor 120 retrieves the context 155 and data 160 in response to the GPU 110 powering up.

Once the trusted processor 120 has authenticated the context 155 and data 160 by verifying that the signature 315 matches the expected signature 320, the trusted processor 120 restores the context 155 to the GPU 110 and restores the data 160 to the frame buffer 115. In some embodiments, if the trusted processor 120 determines that the signature 315 does not match the expected signature 320, the trusted processor 120 does not provide the context 155 and data 160 to the GPU 110. If the trusted processor 120 does not provide the context 155 and data 160 to the GPU 110 such that the GPU 110 can be restored, the trusted processor 120 triggers the full GPU 110 initialization sequence from the non-volatile memory 135. The driver 130, in turn, initializes the internal GPU engines (not shown) that it manages.

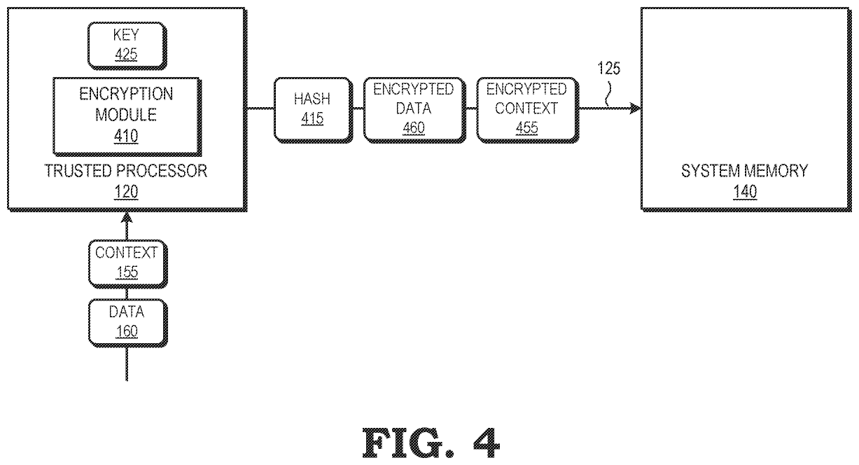

FIG. 4 is a block diagram of the trusted processor 120 encrypting and hashing the context 155 and data 160 of the GPU 110 in response to the GPU 110 powering down, prior to storing the data 160 and context 155 at the system memory 140 in accordance with some embodiments. To provide for cryptographic protection of the context 155 and data 160, the trusted processor 120 includes an encryption module 410 configured to encrypt and decrypt information according to a specified cryptographic standard. In some embodiments, the encryption module 410 is configured to employ Advanced Encryption Standard (AES) encryption and decryption, but in other embodiments the encryption module 410 may employ other encryption/decryption techniques. The encryption module 410 employs a key 425 to encrypt the context 155 and data 160 and provides the encrypted context 455 and encrypted data 460 to the system memory 140 for storage.

In some embodiments, the trusted processor 120 validates the encrypted context 455 and the encrypted data 460 using a validation protocol such as calculating a cryptographic hash (referred to as “hash”) 415, or other protocol to determine whether the encrypted context 455 and the encrypted data 460 are valid. In some embodiments, the trusted processor 120 calculates the hash 415 of the encrypted context 455 and encrypted data 460 using the key 425 and then sends the hash 415, the encrypted context 455 and encrypted data 460 to the system memory 140.

Calculating the hash 415 refers to a procedure in which a variable amount of data is processed by a function to produce a fixed length result, referred to as a hash value. A hash function should be deterministic, such that the same data, presented in the same order should always produce the same hash value. A change in the order of the data or of one or more values of the data should produce a different hash value. A hash function may use a key word, or “hash key,” such that the same data hashed with a different key produces a different hash value. Since the hash value may have fewer unique values that the potential combinations of input data, different combinations of data input may result in the same hash value. For example, a 16-bit hash value will have 65536 unique values, whereas four bytes of data may have over four billion unique combinations. Therefore, a hash value length may be chosen that minimizes the potential duplicate results while not being so long as to make the hash function too complicated or time consuming.

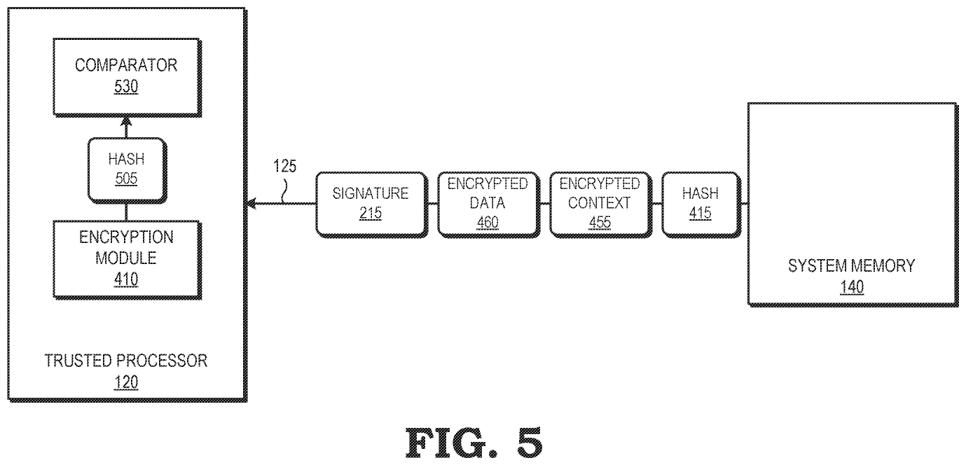

FIG. 5 is a block diagram of the trusted processor 120 verifying that the context 155 and data 160 are untampered in accordance with some embodiments. In response to detecting that the GPU 110 is powering up, the trusted processor 120 retrieves the encrypted context 455, the encrypted data 460, the signature 215, and the hash 415 from the system memory via the interconnect 125. The trusted processor 120 calculates a second hash 505 of the encrypted context 455 and the encrypted data 460 using the key 425. The trusted processor 120 includes a comparator 530 configured to compare the hash 415 to the second hash 505. If the values of the hash 415 to the second hash 505 match, then the trusted processor 120 verifies that the encrypted context 455 and the encrypted data 460 have not been tampered. In response to determining that the encrypted context 455 and the encrypted data 460 have not been tampered, the encryption module 410 decrypts the encrypted context 455 and the encrypted data 460 and restores the context 155 and data 160 to the GPU 110.

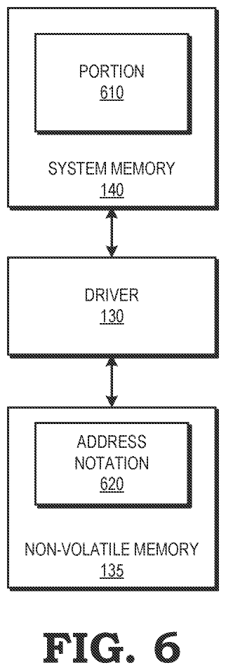

FIG. 6 is a block diagram of the driver 130 allocating a portion 610 of system memory 140 for storing the context 155 and data 160 of the GPU 110 in accordance with some embodiments. In some embodiments, the system memory 140 includes a pre-reserved portion for storing the context 155 and data 160 (or encrypted context 455 and encrypted data 460). If the system memory 140 does not include a pre-reserved portion for storing the context 155 and data 160, in some embodiments, the driver 130 dynamically allocates a portion 610 of the system memory 140 for storing the context 155 and data 160 in response to the GPU 110 powering down. The driver 130 determines the size of the context 155 and data 160 and allocates a sufficient portion 610 of the system memory 140 to store the context 155 and data 160. In some embodiments, the driver saves a notation of the address range of the portion 610, referred to as address notation 620, at non-volatile memory 135. In other embodiments, the driver 130 saves the address notation 620 at another location of the processing system. When the trusted processor 120 detects that the GPU 110 is powering down, the trusted processor 120 accesses the address notation 620 to determine where in the system memory 140 to store the context 155 and data 160 that the trusted processor 120 retrieves from the GPU 110.

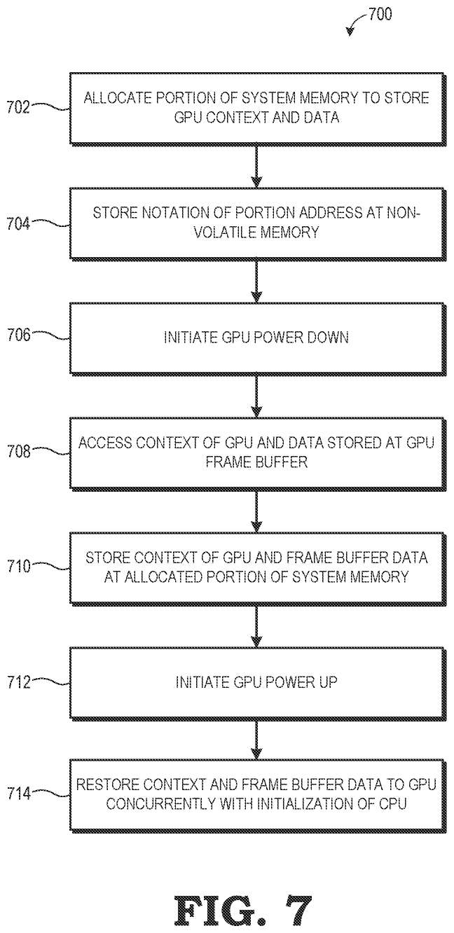

FIG. 7 is a flow diagram illustrating a method 700 for saving and restoring context 155 and data 160 of the GPU 110 concurrent with initialization of the CPU 105 in accordance with some embodiments. At block 702, the driver 130 allocates a portion 610 of the system memory 140 to store the context 155 and data 160 of the GPU 110, if the portion 610 was not pre-reserved. At block 704, the driver 130 stores the address notation 620 of the address range of the portion 610 at non-volatile memory 135 or another location of the processing system 100.

At block 706, the PMC 150 initiates a power state transition of the GPU 110 to power down the GPU 110. At block 708, in response to detecting that the GPU 110 is powering down, the trusted processor 120 accesses the context 155 of the GPU 110 and data 160 stored at the frame buffer 115 of the GPU 110. In some embodiments, the trusted processor 120 encrypts the context 155 and data 160 and generates a hash 415 to secure the context 155 and data 160 and detect tampering. At block 710, the trusted processor stores the context 155 and data 160 (or encrypted context 455 and encrypted data 460) at the portion 610 of the system memory 140.

At block 712, the PMC 150 initiates a power state transition of the GPU 110 to power up the GPU 110. At block 714, in response to detecting that the GPU 110 is powering up, the trusted processor 120 retrieves the context 155 and data 160 (or encrypted context 455 and encrypted data 460) from the portion 610 of the system memory 140. In some embodiments, the trusted processor 120 generates a second hash 505 of the encrypted context 455 and encrypted data 460 and compares the hash 415 to the second hash 505 to determine if the encrypted context 455 and encrypted data 460 have been tampered. The trusted processor 120 decrypts the encrypted context 455 and encrypted data 460 and restores the context 155 and data 160 to the GPU 110 concurrently with initialization of the CPU 105.

In some embodiments, the apparatus and techniques described above are implemented in a system including one or more integrated circuit (IC) devices (also referred to as integrated circuit packages or microchips), such as the processing system described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
accessing, by a trusted processor, context and data of a parallel processor of a processing system in response to the parallel processor powering down;
storing the context and data at a memory; and
restoring the context and data to the parallel processor in response to the parallel processor powering up, the restoration overlapping at least in part with initialization of a central processing unit (CPU) of the processing system.

2. The method of claim 1, further comprising:
encrypting the context and data to generate an encrypted context prior to storing the encrypted context and encrypted data at the memory.

3. The method of claim 2, further comprising:
detecting tampering of the encrypted context and encrypted data prior to restoring the context and data to the parallel processor.

4. The method of claim 3, further comprising:
hashing the context and data to generate a first hash value prior to storing the encrypted context and encrypted data at the memory;
accessing the encrypted context and encrypted data and hashing the encrypted context and encrypted data to generate a second hash value prior to restoring the context and data to the parallel processor; and wherein
detecting comprises comparing the first hash value to the second hash value.

5. The method of claim 1, wherein the parallel processor comprises a graphics processing unit (GPU) and the data accessed by the trusted processor is stored at a frame buffer of the GPU.

6. The method of claim 1, further comprising:
allocating a portion of the memory for storing the context and data in response to the parallel processor powering down.

7. The method of claim 1, further comprising:
bypassing reinitialization of the parallel processor in response to the parallel processor powering up.

8. A method, comprising:
overlapping at least in part with initialization of a central processing unit (CPU) of a processing system, fetching, by a trusted processor, context and data for a parallel processor stored at a memory of a processing system in response to the parallel processor powering up;
verifying, at the trusted processor, that the context and data are untampered; and
restoring the context and data to the parallel processor.

9. The method of claim 8, wherein the parallel processor comprises a graphics processing unit (GPU), further comprising:
accessing, by the trusted processor, the context of the GPU and data stored at a frame buffer of the GPU in response to the GPU powering down;
encrypting and hashing the context and data to generate a first hash value; and
storing the encrypted context and data at the system memory.

10. The method of claim 9, wherein validating comprises:
accessing the encrypted context and data and hashing the encrypted context and data to generate a second hash value prior to restoring the context and data to the GPU; and wherein
detecting comprises comparing the first hash value to the second hash value.

11. The method of claim 9, wherein storing comprises:
storing the encrypted context and data at a pre-reserved portion of the system memory.

12. The method of claim 9, further comprising:
allocating a portion of the system memory for storing the encrypted context and data in response to the GPU powering down.

13. The method of claim 8, further comprising:
bypassing reinitialization of the parallel processor in response to the parallel processor powering up.

14. A device, comprising:
a central processing unit (CPU);
a parallel processor;
a memory; and
a trusted processor configured to:
access a context of the parallel processor and data stored at the parallel processor in response to the parallel processor powering down;
store the context and data at the memory; and
restore the context and data to the parallel processor in response to the parallel processor powering up, overlapping at least in part with initialization of the CPU.

15. The device of claim 14, wherein the trusted processor is to detect tampering of the context and data prior to restoring the context and data to the parallel processor.

16. The device of claim 15, wherein the trusted processor is to:
encrypt the context and data prior to storing the encrypted context and data at the memory.

17. The device of claim 16, wherein the trusted processor is to:
hash the context and data to generate a first hash value prior to storing the encrypted context and encrypted data at the memory;
access the encrypted context and data and hash the encrypted context and data to generate a second hash value prior to restoring the context and data to the parallel processor; and
compare the first hash value to the second hash value.

18. The device of claim 14, wherein the parallel processor comprises a graphics processing unit (GPU) and the data accessed by the trusted processor is stored at a frame buffer of the GPU.

19. The device of claim 14, wherein the trusted processor is to:
allocate a portion of the memory for storing the context and data in response to the parallel processor powering down.

20. The device of claim 14, wherein the parallel processor is to bypass reinitializing in response to the parallel processor powering up.
